(19) United States
(12) Patent Application Publication
(10) Pub. No.: US 2009/0323065 A1
(43) Pub. Date: Dec. 31, 2009

(54) Light Analyzer Device

(75) Inventors: Stuart Owen Goldman, Scottsdale, AZ (US); Paul Daniel Wolfson, Evanston, IL (US)

Correspondence Address: Jay M. Brown, 6409 Fayetteville Road, Suite 120-306, Durham, NC, 27713, US

(73) Assignee: Lucent Technologies Inc., Murray Hill, NJ (US)

(21) Appl. No.: 12/165,642

(22) Filed: Jun. 30, 2008

(51) Int. Cl. G01J 3/46

(52) U.S. Cl. 356/402

(57) ABSTRACT

Apparatus including photodetector device, signal output device, and housing configured to be held in human hand. Signal output device is configured for emitting perceived color signal corresponding to light color data detected by photodetector device. Method that includes: providing apparatus configured to be held in human hand and having photodetector device and signal output device; causing photodetector device to detect light color data from light source; and causing signal output device to emit perceived color signal corresponding to detected light color data.

### BACKGROUND OF THE INVENTION

1. Field of the Invention

This invention generally relates to devices configured to be held in a human hand.

2. Related Art

This section introduces aspects that may help facilitate a better understanding of the invention. Accordingly, the statements of this section are to be read in this light and are not to be understood as admissions about what is prior art or what is not prior art.

Various types of devices configured to be held in a human hand have been developed for a broad spectrum of end-use applications. Such devices have included cellular telephones, personal digital assistants, and laser pointers, as examples. Despite these developments, there is a continuing need for new devices that are configured to be held in a human hand and that are capable of assisting a human end-user.

### SUMMARY

In an example of an implementation, an apparatus is provided, including a photodetector device, a signal output device, and a housing that is configured to be held in a human hand and that includes the photodetector and signal output devices. The signal output device is configured for emitting a perceived color signal corresponding to light color data detected by the photodetector device. As an example, the apparatus may further include circuit logic, or a light-emitting device, or both. The circuit logic may, for example, be configured for analyzing the light color data and for generating the perceived color signal. Further, for example, the photodetector device may include a plurality of photodetectors. In an additional example, the apparatus may include a light processing device configured for directing light onto the photodetector, the light processing device including a differential grating, a prism, a mirror, or a combination.

As another example of an implementation, a method is provided. The method includes providing an apparatus configured to be held in a human hand, having a photodetector device and a signal output device. Further, the method includes causing the photodetector device to detect light color data from a light source. The method additionally includes causing the signal output device to emit a perceived color signal corresponding to the detected light color data. As an example, providing the apparatus in the method may include providing circuit logic and a plurality of photodetectors, and the method may include causing the circuit logic to select one among a plurality of fixed perceived color signals corresponding to the light color data and to generate the perceived color signal. Further, for example, causing the signal output device to emit a perceived color signal in the method may include causing the signal output device to generate at least one signal selected from a sound signal, a vibration signal, a light signal, and a tactile pixel array signal.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a perspective view showing an example of an implementation of an apparatus.

FIG. 2 is a flow chart showing an example of an implementation of a method.

### DETAILED DESCRIPTION

Modern society assumes in many ways that people have normal eyesight. Beyond the overall importance of eyesight to normal human functioning, color detection is of critical importance to normal participation in myriad aspects of civilized life. Understanding traffic signals, instrument indicator lights, maps, multi-colored graphs, and even carrying out socially-acceptable coordination of clothing as examples, all demand not only eyesight—but a normal ability to distinguish between perceived colors of light-emitting objects and between perceived colors of other objects. Unfortunately, millions of sighted people struggle daily with impaired abilities to properly distinguish between various perceived colors. For some of these people, passing through a traffic signal—controlled intersection is an act of faith that the lamp at either the bottom or the right side is always the “green” one, even though they all appear to that person to have the same color. Fully blind people face even greater difficulties—such as distinguishing between various denominations of uniformly-sized paper currency. When a vision-impaired person is faced with one of the above examples of problems in navigating through modern society, often the only reasonable way for them to resolve it is by asking for someone's help. However, doing so requires trust, takes time, and relegates the vision-impaired person to dependence on the good will, patience, availability, and honesty of strangers. Some circumstances, such as a career that frequently requires a worker to distinguish between perceived colors of instrument indicator lights, or between perceived colors of other objects, or between the values of uniformly-sized paper currencies of multiple denominations, effectively serve as barriers to participation or effective function by persons who are blind, color-blind, or otherwise vision-impaired.

Accordingly, an apparatus is provided that may, for example, be utilized by a vision-impaired person to detect or distinguish between perceived colors of light-emitting devices and between perceived colors of other objects.

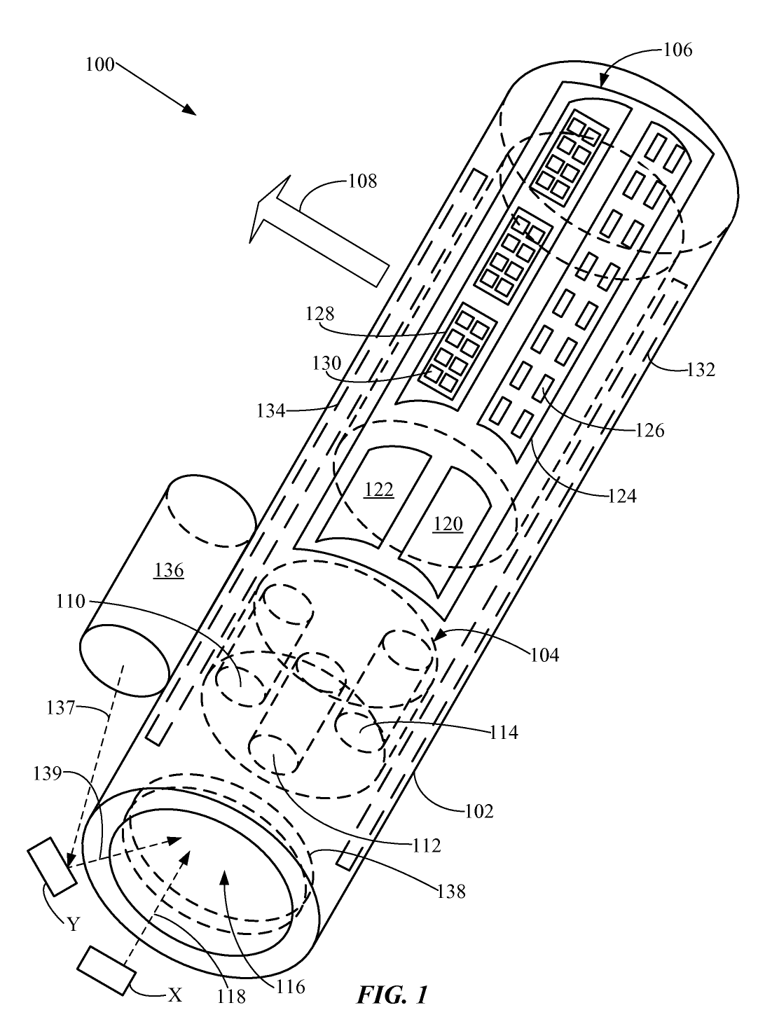

FIG. 1 is a perspective view showing an example 100 of an implementation of an apparatus. The apparatus 100 has a housing 102 configured to be held in a human hand that includes a photodetector device 104 and a signal output device 106. The signal output device 106 is configured for emitting a perceived color signal represented by an arrow 108 corresponding to light color data detected by the photodetector device 104. As examples, the light color data may be an analog or digital signal representing a presence or absence of light detectable by the photodetector device 104; or an analog or digital signal representing a wavelength or wavelength range or an intensity, or one or more wavelengths and an intensity, of light detectable by the photodetector 104. In operation, for example, the vision-impaired user may choose to detect a perceived color of light from a light-emitting device X such as a traffic signal or an instrument indicator light. The user may accordingly aim an aperture 116 of the apparatus 100 so that light from the light-emitting device X may enter the aperture 116 in the direction represented by the arrow 118. The light may then enter the photodetector device 104, generating an output signal carried by a suitable conductor (not shown) to the signal output device 106. The signal output device 106 may then emit a perceived color signal 108 in a mode selected as understandable by the vision-impaired user.

In an example, the photodetector device 104 may include a plurality of photodetectors 110, 112, 114. It is understood throughout this specification by those skilled in the art that the photodetector device 104 may include any selected quantity of photodetectors, such as 2, 10, 100 or 1,000 photodetectors or more (not shown), and that the shape and configuration of the apparatus 100 shown in FIG. 1, including the arrangement of the various components of the apparatus 100 shown in FIG. 1 and discussed herein, is merely an example. Each of the plurality of photodetectors 110, 112, 114 may be configured for selectively detecting light within a different color wavelength range. For example, the photodetectors 110, 112, 114 of the apparatus 100 may be configured for respectively distinguishing between three different perceived colors. Each such perceived color may, for example, span a range of light wavelengths. As an additional example, the photodetector 110 may be configured for selectively detecting light within a first wavelength range of between about 500 nanometers and about 550 nanometers generally perceived as green by normal human eyesight; the photodetector 112 may be configured for selectively detecting light within a second wavelength range of between about 400 nanometers and about 499 nanometers generally perceived as blue by normal human eyesight; and the photodetector 114 may be configured for selectively detecting light within a third wavelength range of between about 600 nanometers and about 650 nanometers generally perceived as red by normal human eyesight. In a further example, the photodetectors 110 and 114 may be configured as in the preceding example, but the photodetector 112 may instead be configured for selectively detecting light within a second wavelength range of between about 570 nanometers and about 580 nanometers generally perceived as yellow by normal human eyesight. Since the latter example facilitates distinguishing between light having green, yellow and red perceived colors, this configuration may be utilized for understanding traffic signals, for example. Further, since traffic signals are typically standardized to a small variety of types and configurations of light-emitting devices X, the apparatus 100 may, for example, be configured to specifically detect and distinguish light within the wavelength ranges typically emitted by the light-emitting devices X commonly utilized respectively in the green, yellow and red light emitters of such traffic signals. As a further example, the apparatus 100 may be configured for distinguishing between perceived colors of light emissions from a plurality of instrument indicators. For example, light-emitting diodes (LEDs) often provide signals having perceived colors such as green, yellow, red, white, or blue. As another example, the apparatus 100 may be configured for distinguishing between light emissions having a plurality of different wavelength ranges of special utility for the end-user in some other application. For example, an apparatus 100 may have a photodetector device 104 including three photodetectors 110, 112, 114 respectively configured to detect and distinguish between blue, yellow and red perceptual colors, sometimes referred to collectively as the “primary colors”.

In another example, each of the plurality of photodetectors 110, 112, 114 may be configured for detecting an intensity of light within a different color wavelength range. Where, for example, the photodetectors 110, 112, 114 are configured for respectively detecting green, yellow and red perceived colors as discussed earlier, the photodetectors 110, 112 114 in this example may additionally be configured to detect relative intensities of light within the three different respective wavelength ranges. Then, for example, the apparatus 100 may be configured to identify a highest relative intensity of light detected by a one among the photodetectors 110, 112, 114, and to cause the signal output device 106 to emit a perceived color signal 108 corresponding to the wavelength range of light that the one photodetector is configured to detect. As an example, the apparatus 100 may be configured to identify such a highest relative intensity of at least about seventy-five percent (75%) and to then cause the signal output device 106 to emit a corresponding perceived color signal 108.

The signal output device 106 may, for example, be configured for generating the perceived color signal 108 in at least one mode selected from a sound signal, a vibration signal, a light signal, and a tactile pixel array signal. As examples of a mode including a sound signal, the apparatus 100 may emit a verbalized message such as “the light is green”, or a tone having a pre-defined pitch, or a series of tones having a pre-defined pattern and meaning. For example, the signal output device 106 may include a loudspeaker 120 configured for emitting the sound signal. As an example of a mode including a vibration signal, the apparatus 100 may emit one or more vibration signals having a pre-defined pattern and meaning. For example, the signal output device 106 may include a vibrator 122 configured for emitting a vibration signal. As examples of a mode including light, the apparatus 100 may emit a visual message having a pre-defined pattern and meaning, such as by a flashing light or by selective illumination of lights arranged in a spaced-apart array, or by displaying a word such as “green”. For example, the signal output device 106 may include an array 124 of spaced-apart LEDs 126. As another example of a mode including a tactile pixel array signal, the apparatus 100 may include a tactile pixel array 128 including tactile pins 130. The apparatus 100 may, for example, selectively extend tactile pins 130 of the tactile pixel array 128 outward from the housing 102 in a predetermined pattern for tactile detection understandable by the end-user. As an example, the predetermined pattern may represent a Braille letter or word, or a symbol, or a number of bars having a predetermined meaning.

As another example, the apparatus 100 may include circuit logic 132 configured for analyzing the light color data and for generating the perceived color signal 108. It is understood by those skilled in the art that circuit logic 132 may be implemented by hardware, or by a combination of hardware and software. As examples, the hardware may include one or more input modules and one or more processing modules. Examples of a processing module include a microprocessor, a general purpose processor, a digital signal processor, a logic or decision processing unit, and an application-specific integrated circuit. If the circuit logic 132 is performed in part by software, the software may for example reside in software memory in such a hardware device (not shown) that is included in circuit logic 132 and is used to execute the software. The software may include an ordered listing of executable instructions for implementing the circuit logic 132 either in digital form such as digital circuitry or source code, or analog circuitry or an analog source such an analog electrical, sound or video signal.

In an example where the apparatus 100 includes circuit logic 132 and where the photodetector device 104 includes a plurality of photodetectors 110, 112, 114, the circuit logic 132 may be configured for generating the perceived color signal 108 and for analyzing the light color data to produce light intensity data.

As another example where the apparatus 100 includes circuit logic 132 and where the photodetector device 104 includes a plurality of photodetectors 110, 112, 114, the apparatus 100 may be configured for accessing perceptual color space data. Further in that example, the circuit logic 132 may be configured for analyzing the light color data together with perceptual color space data, and for generating the perceived color signal 108. According to this example, the apparatus 100 may be capable of precisely identifying a multitude of different perceptual colors. Further, for example, the apparatus 100 may be capable of identifying each of a multitude of perceptual colors by their common names such as “taupe”, or by their digital perceptual color space coordinates. Examples of perceptual color spaces include the National Television System Committee (“NTSC”), Digital Cinema Initiatives (“DCI”), International Electro-technical Commission (“IEC”) and sRGB perceptual color spaces. As an example, the apparatus 100 may include a memory device 134. The memory device 134 may, for example, store the perceptual color space data; or the perceptual color space data may be accessed by a wireless link (not shown). The memory device 134 may also, as examples, store software for execution by the circuit logic 132, or may store other data such as output wavelength reference data for a light-emitting device.

As another example where the apparatus 100 includes circuit logic 132 and where the photodetector device 104 includes a plurality of photodetectors 110, 112, 114, the circuit logic 132 may be configured for determining a perceived color corresponding to light color data detected by at least two photodetectors 110, 112, 114, and for generating the perceived color signal 108. In an example, an apparatus 100 may have a photodetector device 104 including three photodetectors 110, 112, 114 respectively configured to detect and distinguish between blue, yellow and red perceptual colors, sometimes referred to collectively as the “primary colors”. In that example, light color data collectively detected by the photodetectors 110 and 112 may be interpreted as a “green” perceptual color by the apparatus 100. Further in that example, light color data collectively detected by the photodetectors 112 and 114 may be interpreted as “orange” by the apparatus 100.

In another example where the apparatus 100 includes circuit logic 132 and where the photodetector device 104 includes a plurality of photodetectors 110, 112, 114, the apparatus 100 may be configured for accessing output wavelength reference data for a light-emitting device. Further in that example, the circuit logic 132 may be configured for analyzing the light color data together with the output wavelength reference data, and for generating the perceived color signal 108. For example, the output wavelength reference data for the light-emitting device may include stored light color data regarding light emissions 118 by light-emitting devices X to be detected and interpreted by the apparatus 100. As examples, the stored light color data may relate to traffic signals or to instrument indicator lights. In this manner, the example of an apparatus 100 may be configured for specialized end-use applications with sensitivity targeted to detecting and distinguishing perceptual colors of specific light-emitting devices X. As examples, output wavelength reference data for light-emitting devices X may be stored in a memory device 134, or accessed by a wireless link (not shown).

The apparatus 100 may, for example, include a light-emitting device 136. In an example, the light-emitting device 136 may be mounted on the housing 102 as shown in FIG. 1. As another example (not shown) the light-emitting device 136 may be located inside the housing 102. The light-emitting device 136 may be configured, for example, to emit light represented by an arrow 137 for illuminating an object Y. The object Y may be, for example, an object that does not itself emit light. As an example, the object Y may be a clothing article or a printed multi-colored graph. The illuminating light 137 may then be reflected by the object Y into the apparatus 100 as represented by an arrow 139. The light 139 so reflected into the apparatus 100 may then be analyzed to determine a perceived color of the object Y. The light-emitting device 136 may include, as examples, a light-emitting diode, a laser, or an incandescent, fluorescent, halogen, or plasma lamp. For example, a small incandescent lamp such as a wheat-grain bulb may be utilized. A light-emitting device 136 may be selected, for example, that may emit light at relatively white-balanced intensities across the visible wavelength spectrum. In another example, the apparatus 100 may include circuit logic 132 and the light-emitting device 136; and may be configured for accessing output wavelength reference data relating to the light-emitting device 136. The circuit logic 132 may then be configured for analyzing the light color data and for generating the perceived color signal 108. The circuit logic 132 may utilize the output wavelength reference data to compensate for imbalances of light emission intensities in the light-emitting device 136, in generating the perceived color signal 108.

In an additional example, the apparatus 100 may include a light processing device 138 configured for directing light 118, 139 onto the photodetector 104. As examples, the light processing device 138 may include (not shown) one or more differential gratings, one or more prisms, one or more mirrors, or a combination of them. In an example, a differential grating may include a Bragg grating. The light processing device 138 may be configured, as examples, to spectrally split light 118, 139 and to direct that light within different wavelength ranges to different photodetectors 110, 112, 114; or to distribute that light across the visible spectrum to each of a plurality of photodetectors 110, 112, 114.

It is understood by those skilled in the art that the apparatus 100 may include an internal power source (not shown) or wiring to an external power line. It is further understood by those skilled in the art that the apparatus 100 may include power circuitry (not shown) for energizing components such as the signal output device 106, circuit logic 132, memory device 134, and light-emitting device 136. Power circuitry (not shown) may also include on-off switches for the signal output device 106, the circuit logic 132, the memory device 134, and the light-emitting device 136. It is additionally understood by those skilled in the art that the apparatus 100 may include signal circuitry (not shown) for communicating light color data detected by the photodetector device 104. For example, signal circuitry (not shown) may carry light color data from the photodetector device 104 to the circuit logic 132. Further signal circuitry (not shown) may link the circuit logic 132 with the memory device 134 and the signal output device 106.

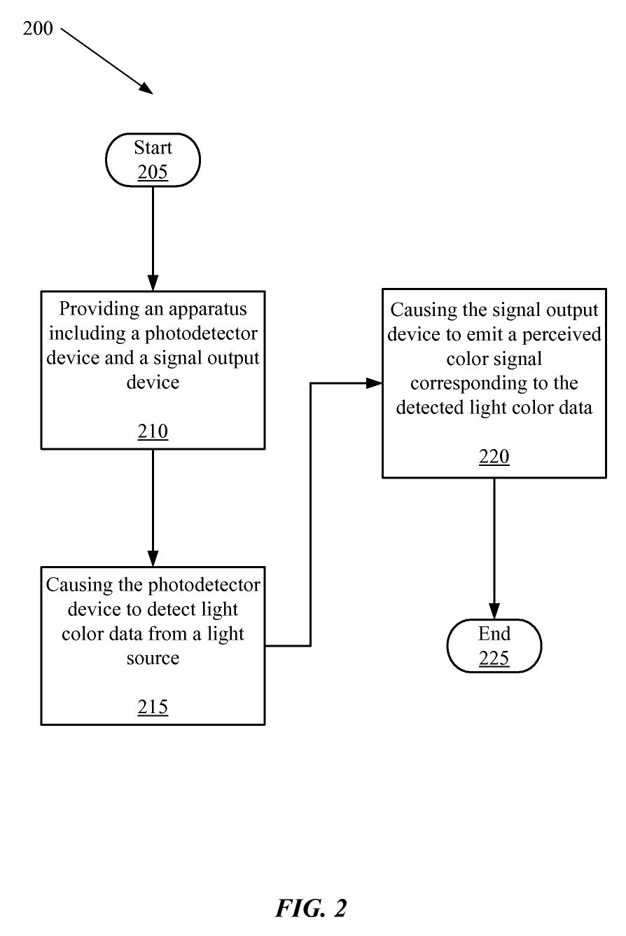

FIG. 2 is a flow chart showing an example of an implementation of a method 200. The method 200 starts at step 205, and then step 210 includes providing an apparatus 100 including a photodetector device 104 and a signal output device 106. At step 215, the photodetector device 104 is caused to detect light color data from a light source such as a light-emitting device X or an object Y. Step 220 includes causing the signal output device 106 to emit a perceived color signal 108 corresponding to the detected light color data. The method 200 may then end at step 225.

As an example, detecting light color data from a light source at step 215 may include quantitatively measuring and analyzing or qualitatively analyzing the light color data. As examples, quantitatively measuring and analyzing the light color data may include determining one or more wavelengths of the light color data, or determining absolute or relative intensities of one or more wavelengths of the light color data, or both. In an example, step 210 may include providing a photodetector device 104 including a plurality of photodetectors 110, 112, 114, and step 215 may include causing each of the plurality of photodetectors 110, 112, 114 to selectively detect light within a different color wavelength range. As another example, step 210 may include causing each of a plurality of photodetectors 110, 112, 114 to detect an intensity of light within such a different color wavelength range. In a further example, causing the signal output device 106 to emit the perceived color signal at step 220 may include selecting one among a plurality of fixed perceived color signals based on the detected light intensities. As an example, causing the signal output device 106 to emit the perceived color signal 108 may include causing the signal output device 106 to generate at least one signal selected from a sound signal, a vibration signal, a light signal, and a tactile pixel array signal. Providing the apparatus 100 at step 210 may, for example, include providing circuit logic 132 and a plurality of photodetectors 110, 112, 114; and step 220 may include causing the circuit logic 132 to analyze the light color data to produce light intensity data, and to generate the perceived color signal 108. In another example where step 210 includes providing circuit logic 132 and a plurality of photodetectors 110, 112, 114, step 220 may include causing the circuit logic 132 to access perceptual color space data, causing the circuit logic 132 to analyze the light color data together with the perceptual color space data, and causing the circuit logic 132 to generate the perceived color signal 108. In a further example where step 210 includes providing circuit logic 132 and a plurality of photodetectors 110, 112, 114, step 220 may include causing the circuit logic 132 to select one among a plurality of fixed perceived color signals corresponding to the light color data, and to generate the perceived color signal 108. In an additional example where step 210 includes providing circuit logic 132 and a plurality of photodetectors 110, 112, 114, step 220 may include causing the circuit logic 132 to access reference data for a light-emitting device, causing the circuit logic 132 to analyze the light color data together with the output wavelength reference data, and causing the circuit logic 132 to generate the perceived color signal 108. As another example, step 210 may include providing circuit logic 132 and a light-emitting device 136; and step 220 may include causing the circuit logic 132 to access output wavelength reference data for the light-emitting device, causing the circuit logic 132 to analyze the light color data together with the output wavelength reference data, and causing the circuit logic 132 to generate the perceived color signal 108.

The apparatus 100 may, for example, be utilized as a personal device for detecting perceived colors of light that is emitted by light-emitting devices X, and of light that illuminates other objects Y. The apparatus 100 may, for example, be utilized for such detections by a vision-impaired person or by a person otherwise having a utility for such detections of perceptual colors. As examples, the apparatus 100 may have applicability in the fields of textiles, clothing, graphic design, interior design, printing, dyeing, and other end-use applications where determining perceptual colors may be useful. As another example, various denominations of uniformly-sized paper currency may be encoded with print having differential perceptual colors, so that an apparatus 100 may be utilized to distinguish between the various denominations. The method 200 may be utilized in connection with operating another suitable apparatus including a photodetector and a signal output device, of which the apparatus 100 disclosed herein are only examples. It is understood by those skilled in the art that the device 100 may be modified consistent with the above discussion of the method 200, and that the method 200 may utilize any apparatus 100. Accordingly, the foregoing discussion of the apparatus 100 is deemed incorporated in the above discussion of the method 200, and the foregoing discussion of the method 200 is deemed incorporated in the above discussion of the apparatus 100. While the foregoing description refers in some instances to the apparatus 100, it is appreciated that the subject matter is not limited to these structures, nor to the structures discussed in the specification. Other configurations of apparatus may be utilized consistent with the teachings herein. Likewise, the method 200 may include additional steps and modifications of the indicated steps.

Moreover, it will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. An apparatus, comprising:
a housing configured to be held in a human hand;
a photodetector device in the housing; and
a signal output device in the housing;
wherein the signal output device is configured for emitting a perceived color signal corresponding to light color data detected by the photodetector device.

2. The apparatus of claim 1, wherein the photodetector device includes a plurality of photodetectors.

3. The apparatus of claim 2, wherein each of the plurality of photodetectors is configured for selectively detecting light within a different color wavelength range.

4. The apparatus of claim 3, wherein each of the plurality of photodetectors is configured for detecting an intensity of the light within the color wavelength range.

5. The apparatus of claim 1, wherein the signal output device is configured for generating the perceived color signal in at least one mode selected from a group consisting of: a sound signal, a vibration signal, a light signal, and a tactile pixel array signal.

6. The apparatus of claim 1, including circuit logic configured for analyzing the light color data and for generating the perceived color signal.

7. The apparatus of claim 1, including circuit logic; wherein the photodetector device includes a plurality of photodetectors, and the circuit logic is configured for analyzing the light color data to produce light intensity data, and wherein the circuit logic is configured for generating the perceived color signal.

8. The apparatus of claim 1, including circuit logic; wherein the photodetector device includes a plurality of photodetectors, and wherein the apparatus is configured for accessing perceptual color space data, and wherein the circuit logic is configured for utilizing perceptual color space data to analyze the light color data, and wherein the circuit logic is configured for generating the perceived color signal.

9. The apparatus of claim 1, including circuit logic; wherein the photodetector device includes a plurality of photodetectors, and wherein the circuit logic is configured for determining a perceived color corresponding to light color data detected by at least two photodetectors, and wherein the circuit logic is configured for generating the perceived color signal.

10. The apparatus of claim 1, including circuit logic; wherein the photodetector device includes a plurality of photodetectors, and wherein the apparatus is configured for accessing output wavelength reference data for a light-emitting device, and wherein the apparatus is configured for analyzing the light color data together with the output wavelength reference data, and wherein the circuit logic is configured for generating the perceived color signal.

11. The apparatus of claim 1, including a light-emitting device.

12. The apparatus of claim 1, including circuit logic and a light-emitting device; wherein the apparatus is configured for accessing output wavelength reference data for the light-emitting device, and wherein the circuit logic is configured for analyzing the light color data together with the output wavelength reference data, and wherein the circuit logic is configured for generating the perceived color signal.

13. The apparatus of claim 1, including a light processing device configured for directing light onto the photodetector, the light processing device including at least one member selected from a group consisting of a differential grating, a prism, and a mirror.

14. A method, comprising:
providing an apparatus configured to be held in a human hand, including a photodetector device and a signal output device;
causing the photodetector device to detect light color data from a light source; and
causing the signal output device to emit a perceived color signal corresponding to the detected light color data.

15. The method of claim 14, wherein the photodetector device includes a plurality of photodetectors, and wherein causing the photodetector device to detect light color data includes causing each of the plurality of photodetectors to selectively detect light within a different color wavelength range.

16. The method of claim 15, including causing each of the plurality of photodetectors to detect an intensity of the light within the color wavelength range.

17. The method of claim 14, wherein causing the signal output device to emit a perceived color signal includes causing the signal output device to generate at least one signal selected from a group consisting of a sound signal, a vibration signal, a light signal, and a tactile pixel array signal.

18. The method of claim 14, wherein providing the apparatus includes providing circuit logic and a plurality of photodetectors; and wherein the method includes causing the circuit logic to analyze the light color data to produce light intensity data, and to generate the perceived color signal.

19. The method of claim 14, wherein providing the apparatus includes providing circuit logic and a plurality of photodetectors; wherein the method includes causing the circuit logic to access perceptual color space data, and wherein the method includes causing the circuit logic to analyze the light color data together with perceptual color space data, and to generate the perceived color signal.

20. The method of claim 14, wherein providing the apparatus includes providing circuit logic and a plurality of photodetectors; and wherein the method includes causing the circuit logic to select one among a plurality of fixed perceived color signals corresponding to the light color data, and to generate the perceived color signal.
